(19) United States
(12) Patent Application Publication
(10) Pub. No.: US 2026/0238618 A1
(43) Pub. Date: Aug. 13, 2026

(54) UTILIZING INTERMEDIATE PROXY SERVERS FOR CIRCULARLY MANAGING TRAFFIC

(71) Applicant: Oxylabs, UAB, Vilnius (LT)

(72) Inventors: Miroslav KOZLOVSKI, Vilnius (LT); Rytis KAPLUNAS, Vilnius (LT); Arnas JUŠKYS, Vilnius (LT)

(73) Assignee: Oxylabs, UAB, Vilnius (LT)

(21) Appl. No.: 19/048,286

(22) Filed: Feb. 7, 2025

(51) Int. Cl. H04L 9/40

(52) U.S. Cl. CPC H04L 63/0281

(57) ABSTRACT

Disclosed herein are system, method, and computer program product embodiments for improving web scraping by using managing proxy servers and intermediate proxy servers to manage traffic within a proxy environment. Responsive to a command message from an exit proxy, a system may establish a first bidirectional stream with a first intermediate proxy server, and a second bidirectional stream with a second intermediate proxy server. The system may receive a request message for content from a target server, and establish a first unidirectional stream with the first intermediate proxy server. A second unidirectional stream may be established between the system and the second intermediate proxy server. The second intermediate proxy server may initiate the second unidirectional stream. The system may transmit the request message to an exit proxy via the first unidirectional stream, receive the content via the second unidirectional stream, and transmit the content to a message service.

### BACKGROUND

### Field

This field is generally related to using managing proxy servers and intermediate proxy servers to manage traffic within a proxy environment.

### Related Art

Web scraping (also known as screen scraping, data mining, web harvesting) is the automated gathering of data from the Internet. It is the practice of gathering data from the Internet through any means other than a human using a web browser. Web scraping is usually accomplished by executing a program that queries a web server and requests data automatically, then parses the data to extract the requested information.

To conduct web scraping, a program known as a web crawler may be used. A web crawler, sometimes called a web spider, is a program or an automated script which performs the first task, i.e. it navigates the web in an automated manner to retrieve data, such as Hypertext Transfer Markup Language (HTML) data, JSONs, XML, and binary files, of the accessed websites. Web scraping is useful for a variety of applications. In a first example, web scraping may be used for search engine optimization. In a second example, web scraping may be used to identify possible copyright. In a third example, web scraping may be useful to check placement of paid advertisements on a webpage. In a fourth example, web scraping may be useful to check prices or products listed on e-commerce websites.

To conduct web scraping, the web request may be sent from a proxy server. The proxy server then makes the request on the web scraper's behalf, collects the response from the web server, and forwards the web page data so that the scraper can parse and interpret the page. When the proxy server forwards the requests, it generally does not alter the underlying content, but merely forwards it back to the web scraper. A proxy server changes the request's source IP address, so the web server is not provided with the geographical location of the scraper. Using the proxy server in this way can make the request appear more organic and thus ensure that the results from web scraping represent what would actually be presented were a human to make the request from that geographical location.

Exit node proxies, or simply exit nodes, are gateways where the traffic hits the Internet. There can be several proxies used to perform a user's request, but the exit node proxy is the final proxy that contacts the target and forwards the information from the target to a user device, perhaps via a previous proxy. There can be several proxies serving the user's request, forming a proxy chain, passing the request through each proxy, with the exit node being the last link in the chain that ultimately passes the request to the target.

Systems and methods are needed for improved web scraping.

### BRIEF SUMMARY

In an embodiment, a method manages traffic in a proxy environment. In the method, in response to a command message, a first bidirectional stream is established between a managing proxy server and a first intermediate proxy server via a communications network. The command message includes a group identifier and an exit proxy identifier of an exit proxy from a plurality of exit proxies, where the managing proxy server monitors a status for each of the plurality of exit proxies. A second bidirectional stream is established between the managing proxy server and a second intermediate proxy server via the communications network. The second intermediate proxy server may initiate the second bidirectional stream, and identify the managing proxy server based executing a hash algorithm. A request message is received, by the managing proxy server via the communications network, specifying content to request from a target server. A first unidirectional stream is established between the managing proxy server and the first intermediate proxy server via the communications network. The request message is transmitted, by the managing proxy server, to the exit proxy via the first unidirectional stream with the first intermediate proxy server. In some embodiments, the request message may be transmitted to an IP address of the exit proxy. A second unidirectional stream is established between the managing proxy server and the second intermediate proxy server via the communications network. The second intermediate proxy server may establish the second unidirectional stream with the managing proxy server. The content from the target server is received by the managing proxy server via the second unidirectional stream with the second intermediate proxy server. The content may have been retrieved from the target server by the exit proxy. The target content is transmitted, by the managing proxy server via the communications network, to a message service.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF THE DRAWINGS

The accompanying drawings are incorporated herein and form a part of the specification.

FIG. 1 is a block diagram illustrating a current proxy environment, according to some embodiments.

FIG. 2 is a block diagram illustrating various functional components of a proxy environment, according to some embodiments.

FIG. 3 depicts a flowchart illustrating a method for using managing proxy servers and intermediate proxy servers to manage traffic within a proxy environment, according to some embodiments.

FIG. 4 depicts a flowchart illustrating a method for handling a proxy server shutdown, according to some embodiments.

FIG. 5 depicts a flowchart illustrating a method for calculating a latency value, according to some embodiments.

FIG. 6 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for using managing proxy servers and intermediate proxy servers to manage traffic within a proxy environment.

Various embodiments of these features will now be discussed with respect to the corresponding figures.

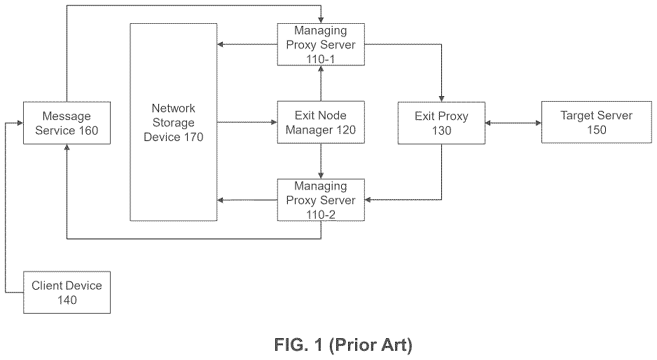

FIG. 1 is a block diagram illustrating a current proxy environment 100, according to some embodiments. Proxy environment 100 includes managing proxy server 110, exit node manager 120, exit proxy 130, client device 140, target server 150, message service 160, and network storage device 170. Current systems typically employ multiple managing proxy servers 110, such as first managing proxy server 110-1 and second managing proxy server 110-2.

Message service 160 may be responsible for receiving and routing requests. Requests may originate from client device 140 and include a web server target such as target server 150. Message service 160 may forward a request from client device 140 to managing proxy server 110. Managing proxy server 110 may identify and route the request to exit proxy 130. As described above, exit proxy 130 may be a gateway where traffic reaches the Internet. For example, exit proxy 130 may handle communication with target server 150 to retrieve content identified in the request.

Current systems may route incoming messages through a first managing proxy server 110-1, and then route outgoing messages through a second managing proxy server 110-2. For example, managing proxy server 110-1 may receive and forward a scraping request to exit proxy 130. Exit proxy 130 may receive and send the results of the scrape request to managing proxy server 110-2. Managing proxy server 110-2 may forward the results to client device 140 via message service 160.

Managing proxy server 110 may maintain a state of exit proxy 130. State may include information such as whether exit proxy 130 is online, offline, number of jobs queued, current job, and quality of service metrics. Quality of service metrics may include, for example, average response time, packet loss, error rate, and out of order delivery. In some embodiments, managing proxy server 110 may use a series of ping-pong messages to measure quality of service of exit proxy 130. Managing proxy server 110 may publish the state of exit proxy to network storage device 170.

For example, a connection may be established between exit proxy 130 and managing proxy servers 110-1 and 110-2. Exit proxy 130 may connect to both managing proxy servers 110-1 and 110-2 by sending a command message to both managing proxy servers 110-1 and 110-2. Both managing proxy servers 110-1 and 110-2 may forward the command message to network storage device 170. This provides a record that a connection has been established between managing proxy servers 110-1 and 110-2 and exit proxy 130. Each managing proxy server 110-1 and 110-2 may further gather state information of exit proxy 130 such as quality of service metrics, and publish the data to network storage device 170.

Exit node manager 120 may further maintain a state of exit proxy 130 by monitoring network storage device 170. Exit node manager 120 may include a state of all exit proxies 130 in proxy environment 100. Exit node manager 120 may obtain state information of exit proxy 130 from data published to network storage device 170. Network storage device 170 may be a message broker. For example, exit node manager 120 may read messages from network storage device 170 indicating that connections have been established between: (1) managing proxy server 110-1 and exit proxy 130; and (2) managing proxy server 110-2 and exit proxy 130. Similarly, exit node manager 120 may obtain quality of service metrics of exit proxy 130 from network storage device 170.

However, this configuration presents difficulties because the state of exit proxy 130 is maintained by at least two entities: (1) each managing proxy server 110 (e.g., managing proxy server 110-1 and 110-2); and (2) exit node manager 120. In proxy environment 100, where exit proxies 130 are updating internal parameters (e.g., IP addresses), receiving updates (e.g., security patches), going offline due to errors/maintenance, coming back online, it is difficult to maintain equivalent state of exit proxy 130 at both managing proxy server 110 and exit node manager 120. Furthermore, network storage device 170 may experience delays and/or errors, thus preventing state of exit proxy 130 from accurately and timely reaching exit node manager 120.

For example, managing proxy server 110-1 may send a ping message to both exit proxy 130 and network storage device 170. Exit proxy 130 may respond with a pong message to managing proxy server 110-2. Managing proxy server 110-2 may forward the pong message to network storage device 170. Exit node manager 120 may retrieve the ping and pong message from network storage device 170, use the timing of the messages to create latency values, and update a state of exit proxy 130. However, the state may be inaccurate based on delays at network storage device 170, or time differences between managing proxy servers 110-1 and 110-2, and network storage device 170. Furthermore, the state may be inaccurate due to packet loss on a network, such as between managing proxy servers 110-1 and 110-2 and network storage device 170, or between exit node manager 120 and network storage device 170. Embodiments address at least some of these issues by using a circular topology for proxy servers.

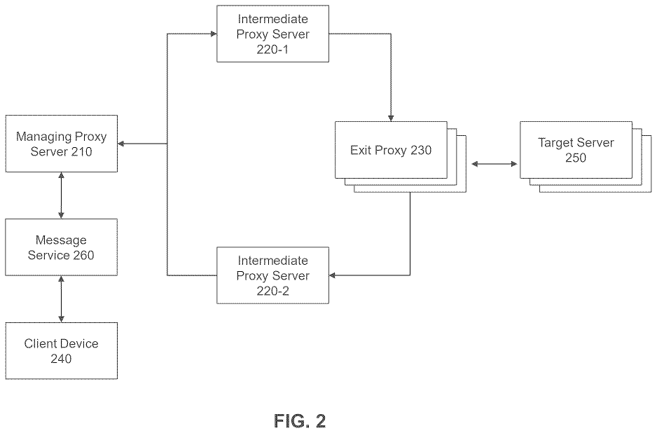

FIG. 2 is a block diagram illustrating various functional components of proxy environment 200, according to some embodiments. Proxy environment 200 includes managing proxy server 210, intermediate proxy server 220, exit proxy 230, client device 240, target server 250, and message service 260. Proxy environment 200 includes technical advantages over proxy environment 100 because managing proxy server 210 maintains the state of exit proxy 230, without having to rely on both network storage device 170 and exit node manager 120.

Message service 260 may receive requests for content at target server 250 from client device 240. Message service 260 may forward the requests to managing proxy server 210. Managing proxy server 210 may employ a circular traffic model, where a first intermediate proxy server 220-1 handles downstream traffic, and a second intermediate proxy server 220-2 handles upstream traffic. Downstream data may be data flowing from client device 240 to target server 250, and upstream traffic may be data flowing from target server 250 to client device 240. As a result, managing proxy server 210 may forward a request to a first intermediate proxy server 220-1, and the first intermediate proxy server 220-1 may forward the request to exit proxy 230. Exit proxy 230 may obtain content from target server 250, and return the results to a second intermediate proxy server 220-2. The second intermediate proxy server 220-2 may forward the results to managing proxy server 210, and managing proxy server 210 may forward the results to message service 260.

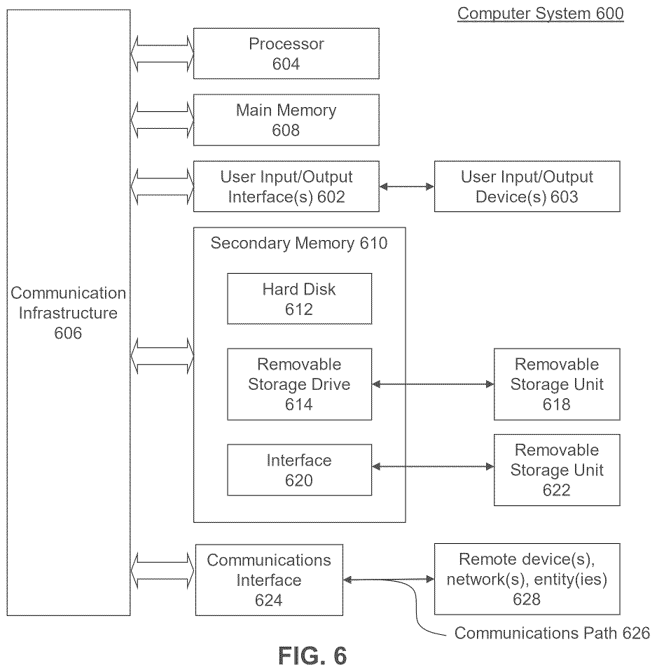

Managing proxy server 210 may be implemented using one or more servers and/or databases. For example, managing proxy server 210 may include one or more proxy servers. In some embodiments, managing proxy server 210 may be implemented using a computing device such as a desktop workstation, laptop or notebook computer, netbook, tablet, smart phone, and/or other computing device. In some embodiments, managing proxy server 210 may be implemented as an application in an enterprise computing system and/or a cloud-computing system. In some embodiments, managing proxy server 210 may be a computer system such as computer system 600 described with reference to FIG. 6. Although proxy environment 200 depicts a single instance of managing proxy server 210, proxy environment 200 may include any number of instances of managing proxy server 210.

Target server 250 may be computer software and underlying hardware that accepts requests and returns responses via HTTP. Proxy environment 200 may include any number of target servers 250. As input, target server 250 may take a path in an HTTP request, any headers in the HTTP request, and a body of the HTTP request, and use that information to generate content to be returned. The content served by the HTTP protocol is often formatted as a webpage, such as using HTML, CSS, and JavaScript. For example, exit proxy 230 may send one or more HTTP requests to target server 250. Target server 250 may return content to exit proxy 230 according to the HTTP request(s).

Client device 240 may be any entity attempting to retrieve content from target server 250. Client device 240 may be a computer system such as computer system 600 described with reference to FIG. 6. Client device 240 may be a client system such as a desktop workstation, laptop or notebook computer, netbook, tablet, smart phone, and/or other computing device that may be using an enterprise computing system. Proxy environment 200 may include any number of client devices 240.

In some embodiments, client device 240 may format the request as a proxy protocol request. To send a request according to an HTTP proxy protocol, the full URL may be passed, instead of just the path. Credentials may be required to access the proxy. All the other fields for an HTTP request may also be determined. To reproduce an HTTP request, client device 240 may generate all the different components of each request, including a method, path, version of the protocol that the request wants to access, headers, and body of the request.

Client device 240 may save a session identifier corresponding to a session with target server 250. Client device 240 may provide the session identifier in subsequent requests for content at target server 250. For example, client device 240 may send a first proxy protocol request for content from target server 250 to message service 260. Message service 260 may forward the first proxy protocol request to managing proxy server 210. Managing proxy server 210 may leverage intermediate proxy servers 220-1 and 220-2, as well as exit proxy 230 to retrieve the content from target server 250. Target server 250 may generate and return a session identifier along with the content. Client device 240 may save the session identifier, and may include the session identifier in a second proxy protocol request for second content from target server 250. By including the session identifier in the second proxy protocol request, target server 250 may respond to the second request based on interactions of the first request.

In some embodiments, managing proxy server 210 may not send the requests directly to target server 250 and instead send them through at least one intermediary proxy server 220, such as intermediate proxy server 220-1. Intermediate proxy server 220 may be implemented using one or more servers and/or databases. In some embodiments, intermediate proxy server 220 may be implemented using a computing device such as a desktop workstation, laptop or notebook computer, netbook, tablet, smart phone, and/or other computing device. In some embodiments, intermediate proxy server 220 may be implemented as an application in an enterprise computing system and/or a cloud-computing system. In some embodiments, intermediate proxy server 220 may be a computer system such as computer system 600 described with reference to FIG. 6. Proxy environment 200 may include any number of intermediate proxy servers 220.

A first intermediate proxy server 220-1 may forward the request to exit proxy 230. Exit proxy 230 may be implemented using one or more servers and/or databases. In some embodiments, exit proxy 230 may be implemented using a computing device such as a desktop workstation, laptop or notebook computer, netbook, tablet, smart phone, and/or other computing device. In some embodiments, exit proxy 230 may be implemented as an application in an enterprise computing system and/or a cloud-computing system. In some embodiments, exit proxy 230 may be a computer system such as computer system 600 described with reference to FIG. 6. Proxy environment 200 may include any number of exit proxies 230.

Here, managing proxy server 210 maintains the state of exit proxy 230, without needing exit node manager 120 and/or network storage device 170. As noted above, managing proxy server 210 uses intermediate proxy servers 220 to communicate with exit proxy 230. Managing proxy server 210 may receive requests from client device 240 for content at target server 250. In some embodiments, a first intermediate proxy server 220-1 may handle downstream data. Thus, managing proxy server 210 may forward the request to intermediate proxy server 220-1, intermediate proxy server 220-1 may identify exit proxy 230 to service the request, and transmit the request to exit proxy 230. Exit proxy 230 may communicate with target server 250 to retrieve the content specified by the request.

In some embodiments, a second intermediate proxy server 220-2 may be configured to handle upstream data. Noted above, upstream data may be data flowing from target server 250 to client device 240. Exit proxy 230 may return the content to intermediate proxy server 220-2. Intermediate proxy server 220-2 may forward the content to managing proxy server 210, and managing proxy server 210 may transmit the content to client device 240.

As noted above, proxy environment 200 employs a circular traffic pattern where requests for content are handled by a first intermediate proxy server 220 (e.g., intermediate proxy server 220-1) and the retrieved content is handled by a second intermediate proxy server 220 (e.g., intermediate proxy server 220-2). Thus, each pair of intermediate proxy servers 220 (e.g., intermediate proxy server 220-1 and intermediate proxy server 220-2) may have a group identifier to identify the pair. In some embodiments, a single intermediate proxy server 220 may be part of multiple pairs. For example, intermediate proxy server 220-1 may also be paired with (e.g., grouped with) a third intermediate proxy server 220.

Exit proxy 230 and intermediate proxy server 220 may be configured to communicate to handle requests. Exit proxy 230 and intermediate proxy server 220 may communicate using any protocol or connection type. For example, exit proxy 230 and intermediate proxy server 220 may communicate using one or more messages. In some embodiments, the messages between exit proxy 230 and intermediate proxy server 220 may utilize a quick UDP internet (QUIC) connection, a TCP connection, UDP, WebSocket, RPC, or any combination thereof.

In some embodiments, exit proxy 230 may initiate communication with intermediate proxy server 220 by sending a command message to intermediate proxy server 220 (e.g., to both intermediate proxy servers 220-1 and 220-2). The command message may include an exit proxy identifier corresponding to exit proxy 230. For example, the exit proxy identifier may be the IP address of exit proxy 230. In some embodiments, intermediate proxy servers 220-1 and 220-2 may each send a command message to exit proxy 230 to establish communication with exit proxy 230.

In some embodiments, intermediate proxy server 220 may ignore a message from exit proxy 230 if the first message received from exit proxy 230 is not a command message. For example, intermediate proxy server 220 may require that to establish communication with exit proxy 230, the first message should be a command message. Otherwise, intermediate proxy 220 may ignore (e.g., refuse) the attempt to communicate by exit proxy 230.

As noted above, proxy environment 200 employs a circular traffic pattern. As a result, requests for content from target server 250 may be received by a first intermediate proxy server 220 (e.g., intermediate proxy server 220-1) and the content may be received by a second intermediate proxy server 220 (e.g., intermediate proxy server 220-2). Thus, when a first intermediate proxy server 220-1 receives a request for content, it may forward the request to exit proxy 230. Exit proxy 230 may retrieve the content from target server 250, and return the content to a second intermediate proxy server 220-2.

Each of the intermediate proxy servers 220 may also establish communications with managing proxy server 210. Intermediate proxy servers 220 may establish communications with managing proxy server 210 responsive to receiving a command message from exit proxy 230. Since proxy environment 200 employs a circular traffic model described above, intermediate proxy servers 220 should communicate with the same managing proxy server 210. This is beneficial so that the same managing proxy server 210 handles forwarding the content requests and receiving the requested content.

In some embodiments, intermediate proxy server 220 may first communicate with managing proxy server 210 by sending a command message to managing proxy server 210. Intermediate proxy server 220 may send managing proxy server 210 a command message in response to receiving a command message from exit proxy 230. Intermediate proxy server 220 may include the exit proxy identifier, received from exit proxy 230, within the command message sent to managing proxy server 210. In some embodiments, managing proxy server 210 may send a command message to intermediate proxy server 220. In some embodiments, managing proxy server 210 may ignore a message from intermediate proxy server 220 if the first message received from intermediate proxy server 220 is not a command message. For example, managing proxy server 210 may require that the first message from intermediate proxy server 220 should be a command message. Otherwise, managing proxy server 210 may ignore (e.g., refuse) the attempt to communicate from intermediate proxy server 220.

As noted above, both intermediate proxy servers 220-1 and 220-2 may communicate with the same managing proxy server 210. Each intermediate proxy server 220 may employ an algorithm to identify managing proxy server 210 to communicate with. For instance, intermediate proxy server 220 may include a list of managing proxy servers 210 and use a hash algorithm to identify managing proxy server 210. Any value may be input to the hash algorithm such as an exit proxy identifier of exit proxy 230, the IP address of exit proxy 230, or any combination thereof. Intermediate proxy server 220 may then calculate the hash value modulo the number of managing proxy servers 210 in proxy environment 200. Intermediate proxy server 220 may select the managing proxy server 210 at the index of the calculated value in the list of managing proxy servers 210. For example, if the hash value modulo the number of managing proxy servers 210 is seven, then intermediate proxy server 220 may select the seventh managing proxy server 210 in the list of managing proxy servers 210. Using this formula, both intermediate proxy servers 220 will identify the same managing proxy server 210 to communicate with, without having to coordinate. Managing proxy server 210 may periodically transmit a heartbeat message to intermediate proxy servers 220. Intermediate proxy servers 220 may use the heartbeat message to maintain the list of managing proxy servers 210. In some embodiments, a list of managing proxy servers 210 may be available at a location on the network.

Managing proxy server 210 may include a data structure storing a list of intermediate proxy servers 220 that managing proxy server 210 has received command messages from. In some embodiments, the data structure may be further organized by both intermediate proxy servers 220 and the exit proxy identifier of exit proxy 230. For example, the list may include both: (1) an identifier of intermediate proxy server 220; and (2) an exit proxy identifier of exit proxy 230 in communication with intermediate proxy server 220.

When managing proxy server 210 receives a command message from intermediate proxy server 220 (e.g., intermediate proxy server 220-1), managing proxy server 210 may wait for a second command message from a different intermediate proxy server 220 (e.g., intermediate proxy server 220-2). Noted above, intermediate proxy servers 220 may be grouped and the group may be assigned an identifier. Managing proxy server 210 may expect to receive a second command message from a different intermediate proxy server 220 (e.g., intermediate proxy server 220-2) having the same group identifier as the first command message. Using the group identifier allows managing proxy server 210 to determine that it may employ a circular traffic pattern with both intermediate proxy servers 220 in the group. Using the group identifier, managing proxy server 210 may also determine which groups of intermediate proxy servers 220 are in use.

In some embodiments, managing proxy server 210 may reset communications with intermediate proxy server 220 (e.g., intermediate proxy server 220-1) that sent the command message if a predetermined amount of time passes and managing proxy server 210 does not receive a command message from a second intermediate proxy server 220 (e.g., intermediate proxy server 220-2). For example, managing proxy server 210 may receive a command message from intermediate proxy server 220-1. Managing proxy server 210 may save an identifier of intermediate proxy server 220-1 and the exit proxy identifier of exit proxy 230 in a data structure. The identifier of intermediate proxy server 220-1 may be the IP address of intermediate proxy server 220-1, a group identifier of intermediate proxy server 220-1, or any other value. Managing proxy server 210 may start a timer to listen for a command message from a second intermediate proxy server 220-2. If the timer expires before managing proxy server 210 receives a command message from a second intermediate proxy server 220-2, managing proxy server 210 may delete details of intermediate proxy server 220-1 from the data structure, requiring intermediate proxy server 220-1 to resend another command message to initiate communications. For example, after the timer expires, managing proxy server 210 may ignore all messages from intermediate proxy server 220-1 except for a command message. If managing proxy server 210 receives another command message from intermediate proxy server 220-1, managing proxy server 210 restarts the timer and listens for communication from another intermediate proxy server 220 (e.g., intermediate proxy server 220-2).

Managing proxy server 210 and intermediate proxy server 220 may communicate using any protocol or connection type. For example, managing proxy server 210 and intermediate proxy server 220 may communicate using a quick UDP internet (QUIC) connection, a TCP connection, UDP, a WebSocket, RPC, or any combination thereof.

Intermediate proxy server 220 and managing proxy server 210 may communicate using two streams. The first stream may be a bidirectional stream. The bidirectional stream may allow for both reading and writing data. The bidirectional stream between intermediate proxy server 220 and managing proxy server 210 may be utilized for command messages. Command messages may be used for management such as establishing communication, terminating communications, ping messages, pong messages.

The second stream may be a unidirectional stream. The unidirectional stream may be used for communications involving target server 250. For example, requests from client device 240 for content from target server 250, and the response from target server 250, may be transmitted via the unidirectional stream. In some embodiments, a unidirectional stream between intermediate proxy server 220 and managing proxy server 210 may be established after managing proxy server 210 receives a request from client device 240 for content from target server 250. Noted above, one intermediate proxy server 220 (e.g., intermediate proxy server 220-1) may handle downstream data and one intermediate proxy server 220 (e.g., intermediate proxy server 220-2) may handle upstream data. Managing proxy server 210 may randomly determine which intermediate proxy server 220 handles upstream data and which intermediate proxy server 220 handles downstream data. For example, managing proxy server 210 may execute a randomized selection function. Randomly determining which intermediate proxy server 220 handles upstream data and which intermediate proxy server 220 handles downstream data helps ensure that upstream and downstream data is more equally allocated between the intermediate proxy servers 220 across requests.

Once managing proxy server 210 determines which intermediate proxy server 220 will handle downstream data, managing proxy server 210 may open a unidirectional stream with the intermediate proxy server 220 configured to handle downstream data. For example, managing proxy server 210 may determine that a first intermediate proxy server 220-1 will handle downstream data. Thus, managing proxy server 210 may open a unidirectional stream with the first intermediate proxy server 220-1 such that managing proxy server 210 sends data on the unidirectional stream (e.g., downstream data) to the first intermediate proxy server 220-1. Managing proxy server 210 may execute the randomized selection function and open the unidirectional stream in response to receiving a request from client device 240.

Managing proxy server 210 may be further configured to wait for a second unidirectional stream (e.g., the upstream unidirectional stream) to be opened. Noted above, the unidirectional stream may be configured such that only the entity establishing the unidirectional stream may write data to the stream. The receiving entity may read the data from the unidirectional stream, but may not be able to write to the stream. Here, since data involving target server 250 is communicated via unidirectional streams, managing proxy server 210 may wait (e.g., listen) for a new unidirectional stream to be opened, such that it may receive data from target server 250.

The second unidirectional stream may be opened by intermediate proxy server 220 configured to handle upstream data (e.g., intermediate proxy server 220-2). Intermediate proxy server 220 configured to handle upstream data may establish the second (e.g., upstream) unidirectional stream responsive to receiving data from target server 250 retrieved by exit proxy 230. Managing proxy server 210 may then receive data (e.g., upstream data) originating from target server 250 via the unidirectional stream with second intermediate proxy server 220-2.

Managing proxy server 210 may generate and store a variable indicating whether the unidirectional stream is for upstream or downstream traffic. For example, the variable may be a 0 if the unidirectional stream is for upstream traffic, and a 1 if the unidirectional stream is for downstream traffic. Similarly the variable may be a string such as “upstream” or “downstream.” Managing proxy server 210 may store the variable in a data structure used to track communications with intermediate proxy servers 220 and exit proxy 230.

Noted above, intermediate proxy server 220 and exit proxy 230 may communicate using one or more messages. Messages between intermediate proxy server 220 and exit proxy 230 may be transmitted in the same direction as the unidirectional stream between managing proxy server 210 and intermediate proxy server 220. Thus, if the unidirectional stream between managing proxy server 210 and intermediate proxy server 220-1 is upstream, messages between intermediate proxy server 220-1 and exit proxy 230 may also be transmitted upstream. Similarly, if the unidirectional stream between managing proxy server 210 and intermediate proxy server 220-2 is downstream, the messages between intermediate proxy server 220-2 and exit proxy 230 may also be transmitted downstream.

In some embodiments, the unidirectional stream between intermediate proxy server 220 and managing proxy server 210 may be terminated once the request for content from target server 250 is complete. For example, in response to sending the content to managing proxy server 210, intermediate proxy server 220 may terminate the unidirectional stream. Similarly, in response to sending the request for content to intermediate proxy server 220, managing proxy server 210 may terminate the unidirectional stream.

Noted above, intermediate proxy server 220 may use a command message to establish communications with managing proxy server 210. Intermediate proxy server 220 may further use command messages to pass management (e.g., state) information to managing proxy server 210. For example, intermediate proxy server 220 may periodically transmit a command message to managing proxy server 210 including state information.

The information may include the exit proxy identifier corresponding to exit proxy 230. Managing proxy server 210 may use the exit proxy identifier to determine which exit proxies 230 are online. For example, intermediate proxy server 220 may send a command message to managing proxy server 210 including a list of exit proxies 230 and corresponding exit proxy identifiers that intermediate proxy server 220 communicates with. As will be discussed below, managing proxy server 210 may use ping-pong messages to determine the status of exit proxy 230. Managing proxy server 210 may include the exit proxy identifier in the ping sent to exit proxy 230. In some embodiments, the exit proxy identifier may be the IP address of exit proxy 230. In some embodiments, the IP address of exit proxy 230 may be in internet protocol version 4 (IPv4) format. In some embodiments, the IP address of exit proxy 230 may be in internet protocol version 6 (IPv6) format. The information may further include a hostname of exit proxy 230. The hostname may resolve to the IP address of exit proxy 230.

Noted above, intermediate proxy servers 220 may be grouped and the group may be assigned an identifier. The command message information may further include the group identifier. The group may include two intermediate proxy servers 220, where one handles downstream data (e.g., data from managing proxy server 210 to exit proxy 230), and one handles upstream data (e.g., data from exit proxy 230 and to managing proxy server 210). Managing proxy server 210 may receive a command message from intermediate proxy server 220 and determine that the group identifier is already present in its current list of group identifiers. This may signify that managing proxy server 210 already has already established one or more streams with the intermediate proxy servers 220 of the group identifier. In response, managing proxy server 210 may ignore the command message. The information may further include whether the intermediate proxy server 220 is responsible for upstream traffic or downstream traffic.

Managing proxy server 210 may be configured to evaluate quality of service of exit proxy 230. Managing proxy server 210 may use a series of ping-pong messages to evaluate quality of service at exit proxy 230. The ping-pong messages may follow the circular traffic pattern described above. For example, managing proxy server 210 may send a ping message to a first intermediate proxy server 220-1. Managing proxy server 210 may include the exit proxy identifier of exit proxy 230 within the ping message. The ping may be sent via the bidirectional stream. Intermediate proxy server 220-1 may forward the ping to exit proxy 230. Intermediate proxy server 220-1 may determine the ping message is for exit proxy 230 based on the exit proxy identifier included in the ping message. Exit proxy 230 may send a pong message to a second intermediate proxy server 220-2. The second intermediate proxy server 220-2 may forward the pong message to managing proxy server 210. Exit proxy 230 and/or second intermediate proxy server 220-2 may include the exit proxy identifier within the pong message. Managing proxy server 210 may calculate a latency value based on an amount of time passed between when it sent the ping message and when it received the pong message. In some embodiments, managing proxy server 210 may repeatedly send ping messages to intermediate proxy server 220.

Managing proxy server 210 may calculate additional quality of service metrics for exit proxy 230. For example, managing proxy server 210 may include data within the ping message and determine whether the data is present and/or has been changed when received in the pong message. Similarly, managing proxy server 210 may send a series of ordered ping packets to exit proxy 230, and determine whether the responsive pong packets are received in the same order. In contrast to proxy environment 100 depicted in FIG. 1, the state of exit proxy 230 is more easily captured and maintained because managing proxy server 210 directly receives, updates, and store the state information. Relying on managing proxy server 210, in contrast to managing proxy server 110, network storage device 170, and exit node manager 120, reduces the number of entities required to maintain state information as well as the number of potential points of failure within the proxy environment.

In some embodiments, managing proxy server 210 may reconfigure which exit proxy 230 is used to communicate with target server 250 based on the quality of service metrics. For example, managing proxy server 210 may determine that a pong from exit proxy 230 was never received or that the time taken to receive the pong from exit proxy 230 was greater than a predefined threshold. In response, managing proxy server 210 may send command messages to intermediate proxy servers 220-1 and 220-2 to communicate with a new exit proxy 230. For example, managing proxy server 210 may reference a data structure listing each intermediate proxy server 220 and an exit proxy 230 in communication with the intermediate proxy server 220. As discussed above, proxy environment 200 may include a plurality of exit proxies 230. Thus, managing proxy server 210 may send a command message to each intermediate proxy server 220 communicating with exit proxy 230 (e.g., a first exit proxy 230) indicating to communicate with a new exit proxy 230 (e.g., a second exit proxy 230).

Both managing proxy server 210 and intermediate proxy server 220 may be configured to handle closed (e.g., aborted, failed) communications. For example, if intermediate proxy server 220 detects a loss of connection with managing proxy server 210, intermediate proxy server 220 may use the hash algorithm described above to communicate with a new managing proxy server 210. In some embodiments, intermediate proxy server 220 may update its list of managing proxy servers 210 to remove managing proxy server 210 it was previously communicating with. By removing managing proxy server 210 from the list, intermediate proxy server 220 ensures that it won't attempt to communicate with the same managing proxy server 210 it lost communication to. Intermediate proxy server 220 may identify a new managing proxy server 210 and send a command message to the new managing proxy server 210. As discussed above, communications between intermediate proxy server 220 and managing proxy server 210 may include both a bidirectional stream and a unidirectional stream.

In some embodiments, managing proxy server 210 may receive a shutdown command. This may be necessary in a situation where managing proxy server 210 needs to be updated. In response to receiving the shutdown command, managing proxy server 210 may close bidirectional streams with the intermediate proxy servers 220. For example, managing proxy server 210 may close a first bidirectional stream with first intermediate proxy server 220-1 and close a second bidirectional stream with second intermediate proxy server 220-2. Managing proxy server 210 may then wait for a predefined time interval (e.g., period of time). The period of time may be included within a settings file at managing proxy server 210.

During the waiting period, managing proxy server 210 may ignore requests from intermediate proxy server 220 to reestablish the bidirectional stream. For example, managing proxy server 210 may receive a request to reestablish the bidirectional stream with intermediate proxy server 220-1. Managing proxy server 210 may ignore the request based on determining the request was received after the shutdown command.

In response to determining the predefined time interval has passed, managing proxy server 210 may close unidirectional streams with intermediate proxy servers 220. For example, managing proxy server 210 may close a first unidirectional stream with first intermediate proxy server 220-1 and close a second unidirectional stream with second intermediate proxy server 220-2.

Waiting for the predefined time interval prior to closing the unidirectional streams is beneficial for completing requests from client device 240. As noted above, the bidirectional streams may be used for command messages and the unidirectional streams may be used to pass data to and from target server 250. If managing proxy server 210 terminated the unidirectional streams upon receiving the shutdown command, there is a risk that the request from client device 240 would not be completed because either: (1) data sent from managing proxy server 210 to target server 250 would be dropped; or (2) data from target server 250 would not be received by managing proxy server 210. Instead, by waiting for a predefined period of time prior to closing the unidirectional stream, there is a reduced risk that managing proxy server 210 will interrupt a request in progress.

After a first managing proxy server 210 receives the shutdown command, the bidirectional stream between intermediate proxy server 220 and the first managing proxy server 210 may be terminated. Intermediate proxy server 220 may open a new bidirectional stream with a second managing proxy server 210. However, as noted above, the unidirectional streams may remain open for a predefined time period. Thus, the unidirectional stream between intermediate proxy server 220 and the first managing proxy server 210 may remain open. As a result, intermediate proxy server 220 may be in communication with two managing proxy servers 210 simultaneously. Specifically, intermediate proxy server 220 may have a unidirectional stream with the first managing proxy server 210, and a bidirectional stream with the second managing proxy server 210. Here, data retrieved by exit proxy 230 from target server 250 may be received at the first managing proxy server 210 via intermediate proxy server 220. At the same time, intermediate proxy server 220 may receive a request message for content at target server 250 from the second managing proxy server 210. After the predefined time interval, the unidirectional stream between intermediate proxy server 220 and the first managing proxy server 210 may be terminated. In some embodiments, the first managing proxy server 210 may terminate the unidirectional stream. In some embodiments intermediate proxy server 220 may terminate the unidirectional stream. As a result, intermediate proxy server 220 may only communicate with the second managing proxy server 210.

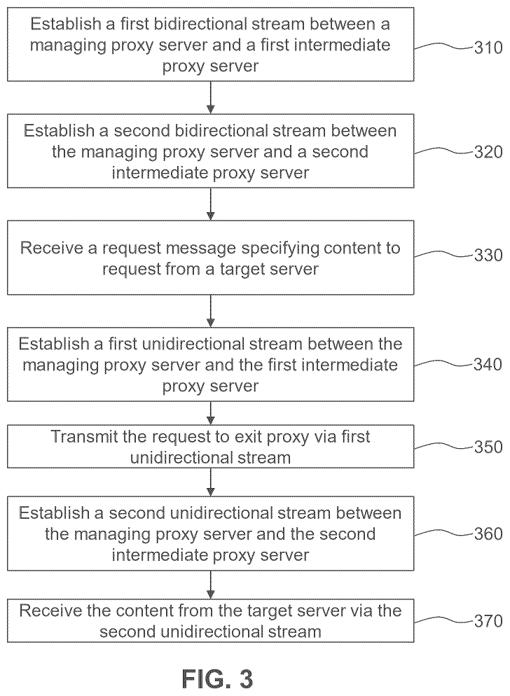

FIG. 3 depicts a flowchart illustrating a method 300 for using managing proxy servers and intermediate proxy servers to manage traffic within a proxy environment, according to some embodiments. Method 300 shall be described with reference to FIG. 2, however, method 300 is not limited to that example embodiment.

In an embodiment, managing proxy server 210 may utilize method 300 to manage traffic within a proxy environment. The foregoing description will describe an embodiment of the execution of method 300 with respect to managing proxy server 210. While method 300 is described with reference to managing proxy server 210, method 300 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3.

At 310, a first bidirectional stream is established between managing proxy server 210 and a first intermediate proxy server 220-1. The first bidirectional stream may be established in response to receiving a command message from exit proxy 230. In some embodiments, managing proxy server 210 may establish the first bidirectional stream by sending a command message to intermediate proxy server 220-1 via a communications network. In some embodiments, intermediate proxy server 220-1 may establish the first bidirectional stream by sending a command message to managing proxy server 210 via a communications network. The first bidirectional stream may be part of or utilize a QUIC connection, a TCP connection, UDP, a WebSocket, RPC, or any combination thereof.

At 320, a second bidirectional stream is established between managing proxy server 210 and a second intermediate proxy server 220-2. In some embodiments, managing proxy server 210 may establish the second bidirectional stream by sending a command message to intermediate proxy server 220-2 via a communications network. In some embodiments, intermediate proxy server 220-2 may establish the second bidirectional stream by sending a command message to managing proxy server 210 via a communications network. The first intermediate proxy server 220-1 and second intermediate proxy server 220-2 may be paired such that they share a group identifier.

At 330, request message is received specifying content to request from target server 250. Managing proxy server 210 may receive the request. The request may originate from client device 240.

At 340, a first unidirectional stream is established between managing proxy server 210 and the first intermediate proxy server 220-1. Managing proxy server 210 may identify the first intermediate proxy server 220-1 to open the first unidirectional stream with by executing a randomized selection function. Managing proxy server 210 may then establish the first unidirectional stream with the first intermediate proxy server 220-1. Noted above, since managing proxy server 210 established the unidirectional stream, managing proxy server 210 may write to the first unidirectional stream and the first intermediate proxy server 220-1 may only read from the first unidirectional stream.

At 350, a request is transmitted to exit proxy 230 via the first unidirectional stream. Managing proxy server 210 may transmit the request to exit proxy 230. Managing proxy server 210 may first transmit the request to the first intermediate proxy server 220-1. The first intermediate proxy server 220-1 may transmit the request to exit proxy 230.

At 360, a second unidirectional stream is established between managing proxy server 210 and the second intermediate proxy server 220-2. The second intermediate proxy server 220-2 may establish the second unidirectional stream with managing proxy server 210. The second intermediate proxy server 220-2 may establish the second unidirectional stream in response to receiving content from exit proxy 230. Exit proxy 230 may have retrieved the content from target server 250. Since the second intermediate proxy server 220-2 established the second unidirectional stream, managing proxy server 210 may only read from the second unidirectional stream and second intermediate proxy server 220-2 may write to the second unidirectional stream.

At 370, content from target server 250 is received via the second unidirectional stream. Managing proxy server 210 may receive the content from the second intermediate proxy server 220-2. The second intermediate proxy server 220-2 may receive the content from exit proxy 230, and transmit the content to managing proxy server 210. Managing proxy server 210 may transmit the received content to message service 260. In some embodiments, managing proxy server 210 may transmit the received content to client device 240.

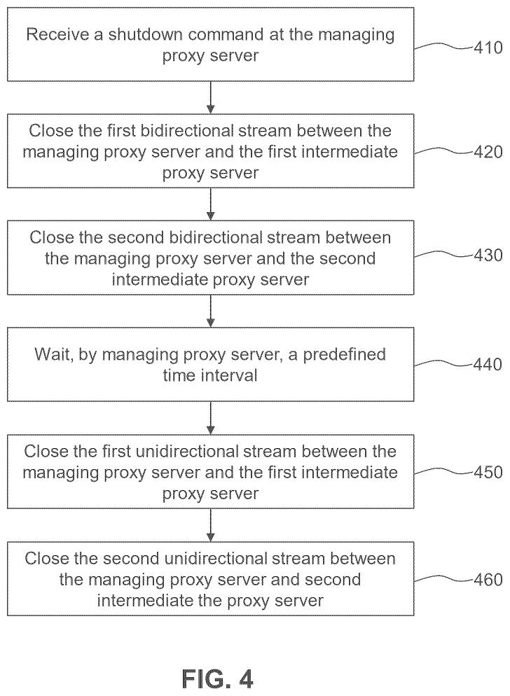

FIG. 4 depicts a flowchart illustrating a method for handling a proxy server shutdown, according to some embodiments. Method 400 shall be described with reference to FIG. 2, however, method 400 is not limited to that example embodiment.

In an embodiment, managing proxy server 210 may utilize method 400 to handle a shutdown command. The foregoing description will describe an embodiment of the execution of method 400 with respect to managing proxy server 210. While method 400 is described with reference to managing proxy server 210, method 400 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4.

At 410, managing proxy server 210 receives a shutdown command. Managing proxy server 210 may receive the shutdown command in order to receive an update, security patch, or other form of maintenance. After receiving the shutdown command, managing proxy server 210 may ignore new communication attempts from intermediate proxy servers 220.

At 420, the first bidirectional stream between the managing proxy server 210 and the first intermediate proxy server 220-1 is closed. In some embodiments, managing proxy server 210 may close the first bidirectional stream. In some embodiments, the first intermediate proxy server 220-1 may close the first bidirectional stream.

At 430, the second bidirectional stream between the managing proxy server 210 and the second intermediate proxy server 220-2 is closed. In some embodiments, managing proxy server 210 may close the second bidirectional stream. In some embodiments, the second intermediate proxy server 220-2 may close the second bidirectional stream.

At 440, managing proxy server 210 waits for a predefined time interval. The predefined time interval may be any amount of time such as ten seconds, one minute, or five minutes. Managing proxy server 210 may update or change the predefined time interval. Managing proxy server 210 may use the number of pending requests for target server 250 to calculate the time interval. For example, the more requests for content at target server 250 that are pending, the longer the predefined time interval may be. In some embodiments, if managing proxy server 210 determines that no requests for content at target server 250 are pending, managing proxy server 210 may not wait any time.

At 450, once the predefined time interval has passed, the first unidirectional stream between the managing proxy server 210 and the first intermediate proxy server 220-1 is closed. In some embodiments, managing proxy server 210 may close the first unidirectional stream. In some embodiments, first intermediate proxy server 220-1 may close the first unidirectional stream.

At 460, once the predefined time interval has passed, the second unidirectional stream between managing proxy server 210 and the second intermediate the proxy server 220-2 is closed. In some embodiments, managing proxy server 210 may close the second unidirectional stream. In some embodiments, the second intermediate proxy server 220-2 may close the second unidirectional stream.

As noted above, managing proxy server 210 may close the first and second unidirectional streams after the predefined time interval has passed to ensure that content from target server 250 is received prior to severing the stream.

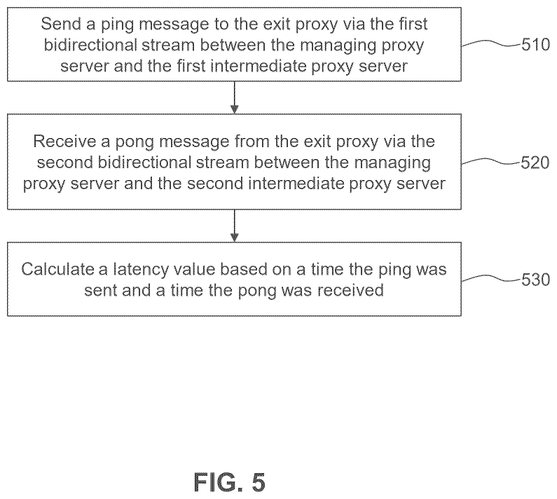

FIG. 5 depicts a flowchart illustrating a method for calculating a latency value, according to some embodiments. Method 500 shall be described with reference to FIG. 2, however, method 500 is not limited to that example embodiment.

In an embodiment, managing proxy server 210 may utilize method 500 to calculate a latency value or other quality of service metric for exit proxy 230. The foregoing description will describe an embodiment of the execution of method 500 with respect to managing proxy server 210. While method 500 is described with reference to managing proxy server 210, method 500 may be executed on any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5.

At 510, managing proxy server 210 sends a ping message to exit proxy 230 via the first bidirectional stream between managing proxy server 210 and the first intermediate proxy server 220-1. Managing proxy server 210 may identify exit proxy 230 based on data from the first intermediate proxy server 220-1. For example, the first intermediate proxy server 220-1 may transmit a command message to managing proxy server 210 including an exit proxy identifier (e.g., an IP address) of exit proxy 230. In some embodiments, managing proxy server 210 may include data within the ping message expected to be received in the pong message.

At 520, managing proxy server 210 receives a pong message from exit proxy 230 via the second bidirectional stream between managing proxy server 210 and the second intermediate proxy server 220-2.

At 530, managing proxy server 210 calculates a latency value based on a time the ping was sent and a time the pong was received. In some embodiments, managing proxy server 210 may compare the latency time to a predefined latency threshold. If the latency time is greater than the predefined latency threshold, managing proxy server 210 may transmit a message to intermediate proxy servers 220-1 and 220-2 including a command to cease communications with exit proxy 230. In some embodiments, managing proxy server 210 may determine whether the pong message includes the data sent in the ping message. Similarly, if the pong message is missing the data, managing proxy server 210 may transmit a message to intermediate proxy servers 220-1 and 220-2 including a command to cease communications with exit proxy 230.

Although method 500 describes calculating latency based on ping-pong messages, managing proxy server 210 may use other messages for calculating latency and other quality of service metrics. For example, managing proxy server 210 may calculate quality of service metrics based off messages involving target server 250. For example, managing proxy server may calculate a latency value based on the time it transmits a content request message to intermediate proxy server 220-1, and the time it receives the requested content from target server 250 via intermediate proxy server 220-2.

The disclosure presents a method for managing traffic within a proxy environment, comprising:
in response to a command message from an exit proxy, establishing between a managing proxy server and a first intermediate proxy server, a first bidirectional stream via a communications network, wherein the command message comprises a group identifier and an exit proxy identifier of an exit proxy from a plurality of exit proxies, wherein the managing proxy server monitors a status for each of the plurality of exit proxies;
establishing, between the managing proxy server and a second intermediate proxy server, a second bidirectional stream via the communications network, wherein the second intermediate proxy server identifies the managing proxy server based executing a hash algorithm;
receiving, by the managing proxy server via the communications network, a request message specifying content to request from a target server;
establishing, between the managing proxy server and the first intermediate proxy server, a first unidirectional stream via the communications network;
transmitting, by the managing proxy server, the request message to the exit proxy via the first unidirectional stream with the first intermediate proxy server;
establishing, between the managing proxy server and the second intermediate proxy server, a second unidirectional stream via the communications network;
receiving, by the managing proxy server, the content from the target server via the second unidirectional stream with the second intermediate proxy server, wherein the content was retrieved from the target server by the exit proxy; and; transmitting, by the managing proxy server via the communications network, the target content to a message service.

The method is presented, wherein the second unidirectional stream is established by the second intermediate proxy server and in response to the second intermediate proxy server receiving the content from the target server wherein.

The method is presented, further comprising:
receiving, by the managing proxy server via the communications network, a shutdown command;
closing, by the managing proxy server, the first bidirectional stream with the first intermediate proxy server;
closing, by the managing proxy server, the second bidirectional stream with the second intermediate proxy server;
after first and second bidirectional streams are closed, waiting, by the managing proxy server, a predefined time interval;
in response to determining that the predefined time interval has passed:
closing, by the managing proxy server, the first unidirectional stream with the first intermediate proxy server when the first unidirectional stream is not closed yet; and
closing, by the managing proxy server, the second unidirectional stream with the second intermediate proxy server when the second unidirectional stream is not closed yet.

The method is presented, further comprising:
receiving, by the managing proxy server from the first intermediate proxy server, a request to reestablish the first bidirectional stream; and
ignoring, by the managing proxy server, the request based on determining that the request was received after the shutdown command was received

The method is presented, wherein the first unidirectional stream between the managing proxy server and the first intermediate proxy server is based on the managing proxy server executing a randomized selection function.

The method is presented, further comprising:
sending, by the managing proxy server via the communications network, a ping message to the exit proxy via the first bidirectional stream with the first intermediate proxy server;
receiving, by the managing proxy server via the communications network, a pong message from the exit proxy, wherein the pong message is received via the second bidirectional stream with second intermediate proxy server, and wherein the pong message is responsive to the ping message; and
calculating, by the managing proxy server, a latency value based on a time the ping message was sent and a time the pong message was received.

The method is presented, further comprising repeatedly sending, by the managing proxy server, the ping message according to a predefined frequency.

The method is presented, wherein the first and second bidirectional streams and the first and second unidirectional streams are one of: quick UDP internet connections (QUIC), TCP connections, UDP, WebSocket, or RPC.

A managing proxy server is presented for managing traffic within a proxy environment, comprising:
at least one processor;
a memory configured to:
   in response to a command message from an exit proxy, establish between the managing proxy server and a first intermediate proxy server, a first bidirectional stream via a communications network, wherein the command message comprises a group identifier and an exit proxy identifier of an exit proxy from a plurality of exit proxies, wherein the managing proxy server monitors a status for each of the plurality of exit proxies;
   establish, between the managing proxy server and a second intermediate proxy server, a second bidirectional stream via the communications network, wherein the second intermediate proxy server identifies the managing proxy server based executing a hash algorithm;
   receive, via the communications network, a request message specifying content to request from a target server;
   establish, between the managing proxy server and the first intermediate proxy server, a first unidirectional stream via the communications network;
   transmit the request message to the exit proxy via the first unidirectional stream with the first intermediate proxy server;
   establish, between the managing proxy server and the second intermediate proxy server, a second unidirectional stream via the communications network;
   receive the content from the target server via the second unidirectional stream with the second intermediate proxy server, wherein the content was retrieved from the target server by the exit proxy; and
   transmit, via the communications network, the target content to a message service.

The managing proxy server is presented, wherein the second unidirectional stream is established by the second intermediate proxy server and in response to the second intermediate proxy server receiving the content from the target server.

The managing proxy server is presented, wherein the at least one processor is further configured to:
receive, via the communications network, a shutdown command;
close the first bidirectional stream with the first intermediate proxy server;
close the second bidirectional stream with the second intermediate proxy server;
after first and second bidirectional streams are closed, wait for a predefined time interval;
in response to determining that the predefined time interval has passed:
close the first unidirectional stream with the first intermediate proxy server when the first unidirectional stream is not closed yet; and
close the second unidirectional stream with the second intermediate proxy server when the second unidirectional stream is not closed yet.

The managing proxy server is presented, wherein the at least one processor is further configured to:
receive, from the first intermediate proxy server, a request to reestablish the first bidirectional stream; and
ignore the request based on determining that the request was received after the shutdown command was received.

The managing proxy server is presented, wherein the at least one processor is further configured to wherein the first unidirectional stream between the managing proxy server and the first intermediate proxy server is based on the managing proxy server executing a randomized selection function.

The managing proxy server is presented, wherein the at least one processor is further configured to:
send, via the communications network, a ping message to the exit proxy via the first bidirectional stream with the first intermediate proxy server;
receive, via the communications network, a pong message from the exit proxy, wherein the pong message is received via the second bidirectional stream with second intermediate proxy server, and wherein the pong message is responsive to the ping message; and
calculate a latency value based on a time the ping message was sent and a time the pong message was received.

The managing proxy server is presented, wherein the at least one processor is further configured to repeatedly send the ping message according to a predefined frequency.

The managing proxy server is presented, wherein the first and second bidirectional streams and the first and second unidirectional streams are one of: quick UDP internet connections (QUIC), TCP connections, UDP, WebSocket, or RPC.

The disclosure presents a non-transitory computer-readable device having instructions stored thereon is presented that, when executed by at least one computing device, cause the at least one computing device to perform operations, comprising:
in response to a command message from an exit proxy, establishing between a managing proxy server and a first intermediate proxy server, a first bidirectional stream via a communications network, wherein the command message comprises a group identifier and an exit proxy identifier of an exit proxy from a plurality of exit proxies, wherein the managing proxy server monitors a status for each of the plurality of exit proxies;
establishing, between the managing proxy server and a second intermediate proxy server, a second bidirectional stream via the communications network, wherein the second intermediate proxy server identifies the managing proxy server based executing a hash algorithm;
receiving, by the managing proxy server via the communications network, a request message specifying content to request from a target server;
establishing, between the managing proxy server and the first intermediate proxy server, a first unidirectional stream via the communications network;
transmitting, by the managing proxy server, the request message to the exit proxy via the first unidirectional stream with the first intermediate proxy server;
establishing, between the managing proxy server and the second intermediate proxy server, a second unidirectional stream via the communications network;
receiving, by the managing proxy server, the content from the target server via the second unidirectional stream with the second intermediate proxy server, wherein the content was retrieved from the target server by the exit proxy; and;
transmitting, by the managing proxy server via the communications network, the target content to a message service.

The device is presented, wherein the second unidirectional stream is established by the second intermediate proxy server and in response to the second intermediate proxy server receiving the content from the target server

The device is presented, the operations further comprising:
receiving, by the managing proxy server via the communications network, a shutdown command;
closing, by the managing proxy server, the first bidirectional stream with the first intermediate proxy server;
closing, by the managing proxy server, the second bidirectional stream with the second intermediate proxy server;
after first and second bidirectional streams are closed, waiting, by the managing proxy server, a predefined time interval;
in response to determining that the predefined time interval has passed:
   closing, by the managing proxy server, the first unidirectional stream with the first intermediate proxy server when the first unidirectional stream is not closed yet; and
   closing, by the managing proxy server, the second unidirectional stream with the second intermediate proxy server when the second unidirectional stream is not closed yet.

The device is presented, the operations further comprising:
receiving, by the managing proxy server from the first intermediate proxy server, a request to reestablish the first bidirectional stream; and
ignoring, by the managing proxy server, the request based on determining that the request was received after the shutdown command was received.

The device is presented, wherein the first unidirectional stream between the managing proxy server and the first intermediate proxy server is based on the managing proxy server executing a randomized selection function.

The device is presented, the operations further comprising:
sending, by the managing proxy server via the communications network, a ping message to the exit proxy via the first bidirectional stream with the first intermediate proxy server;
receiving, by the managing proxy server via the communications network, a pong message from the exit proxy, wherein the pong message is received via the second bidirectional stream with second intermediate proxy server, and wherein the pong message is responsive to the ping message; and
calculating, by the managing proxy server, a latency value based on a time the ping message was sent and a time the pong message was received.

The device is presented, the operations further comprising repeatedly sending, by the managing proxy server, the ping message according to a predefined frequency.

The device is presented, wherein the first and second bidirectional streams and the first and second unidirectional streams are one of: quick UDP internet connections (QUIC), TCP connections, UDP, WebSocket, or RPC.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (e.g., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for managing traffic within a proxy environment, the method comprising:
in response to a command message from an exit proxy, establishing between a managing proxy server and a first intermediate proxy server, a first bidirectional stream via a communications network, wherein the command message comprises a group identifier and an exit proxy identifier of an exit proxy from a plurality of exit proxies, wherein the managing proxy server monitors a status for each of the plurality of exit proxies;
establishing, between the managing proxy server and a second intermediate proxy server, a second bidirectional stream via the communications network, wherein the second intermediate proxy server identifies the managing proxy server based executing a hash algorithm;
receiving, by the managing proxy server via the communications network, a request message specifying content to request from a target server;
establishing, between the managing proxy server and the first intermediate proxy server, a first unidirectional stream via the communications network;
transmitting, by the managing proxy server, the request message to the exit proxy via the first unidirectional stream with the first intermediate proxy server;
establishing, between the managing proxy server and the second intermediate proxy server, a second unidirectional stream via the communications network;
receiving, by the managing proxy server, the content from the target server via the second unidirectional stream with the second intermediate proxy server, wherein the content was retrieved from the target server by the exit proxy; and
transmitting, by the managing proxy server via the communications network, the target content to a message service.

2. The method of claim 1, wherein the second unidirectional stream is established by the second intermediate proxy server and in response to the second intermediate proxy server receiving the content from the target server.

3. The method of claim 1, further comprising:
receiving, by the managing proxy server via the communications network, a shutdown command;
closing, by the managing proxy server, the first bidirectional stream with the first intermediate proxy server;
closing, by the managing proxy server, the second bidirectional stream with the second intermediate proxy server;
after the first and second bidirectional streams are closed, waiting, by the managing proxy server, a predefined time interval;
in response to determining that the predefined time interval has passed:
closing, by the managing proxy server, the first unidirectional stream with the first intermediate proxy server when the first unidirectional stream is not closed yet; and
closing, by the managing proxy server, the second unidirectional stream with the second intermediate proxy server when the second unidirectional stream is not closed yet.

4. The method of claim 3, further comprising:
receiving, by the managing proxy server from the first intermediate proxy server, a request to reestablish the first bidirectional stream; and
ignoring, by the managing proxy server, the request based on determining that the request was received after the shutdown command was received.

5. The method of claim 1, wherein the first unidirectional stream between the managing proxy server and the first intermediate proxy server is based on the managing proxy server executing a randomized selection function.

6. The method of claim 1, further comprising:
sending, by the managing proxy server via the communications network, a ping message to the exit proxy via the first bidirectional stream with the first intermediate proxy server;
receiving, by the managing proxy server via the communications network, a pong message from the exit proxy, wherein the pong message is received via the second bidirectional stream with second intermediate proxy server, and wherein the pong message is responsive to the ping message; and
calculating, by the managing proxy server, a latency value based on a time the ping message was sent and a time the pong message was received.

7. The method of claim 6, further comprising repeatedly sending, by the managing proxy server, the ping message according to a predefined frequency.

8. The method of claim 1, wherein the first and second bidirectional streams and the first and second unidirectional streams are one of: quick UDP internet connections (QUIC), TCP connections, UDP, WebSocket, or RPC.

9. A managing proxy server for managing traffic within a proxy environment, the system comprising:
a memory; and
at least one processor coupled to the memory and configured to:
in response to a command message from an exit proxy, establish between the managing proxy server and a first intermediate proxy server, a first bidirectional stream via a communications network, wherein the command message comprises a group identifier and an exit proxy identifier of an exit proxy from a plurality of exit proxies, wherein the managing proxy server monitors a status for each of the plurality of exit proxies;
establish, between the managing proxy server and a second intermediate proxy server, a second bidirectional stream via the communications network, wherein the second intermediate proxy server identifies the managing proxy server based executing a hash algorithm;
receive, via the communications network, a request message specifying content to request from a target server;
establish, between the managing proxy server and the first intermediate proxy server, a first unidirectional stream via the communications network;
transmit the request message to the exit proxy via the first unidirectional stream with the first intermediate proxy server;
establish, between the managing proxy server and the second intermediate proxy server, a second unidirectional stream via the communications network;
receive the content from the target server via the second unidirectional stream with the second intermediate proxy server, wherein the content was retrieved from the target server by the exit proxy; and
transmit, via the communications network, the target content to a message service.

10. The managing proxy server of claim 9, wherein the second unidirectional stream is established by the second intermediate proxy server and in response to the second intermediate proxy server receiving the content from the target server.

11. The managing proxy server of claim 9, wherein the at least one processor is further configured to:
receive, via the communications network, a shutdown command;
close the first bidirectional stream with the first intermediate proxy server;
close the second bidirectional stream with the second intermediate proxy server;
after the first and second bidirectional streams are closed, wait for a predefined time interval;
in response to determining that the predefined time interval has passed:
close the first unidirectional stream with the first intermediate proxy server when the first unidirectional stream is not yet closed; and
close the second unidirectional stream with the second intermediate proxy server when the second unidirectional stream is not yet closed.

12. The managing proxy server of claim 11, wherein the at least one processor is further configured to:
receive, from the first intermediate proxy server, a request to reestablish the first bidirectional stream; and
ignore the request based on determining that the request was received after the shutdown command was received.

13. The managing proxy server of claim 9, wherein the first unidirectional stream between the managing proxy server and the first intermediate proxy server is based on the at least one processor of the managing proxy server executing a randomized selection function.

14. The managing proxy server of claim 9, wherein the at least one processor is configured to:
send, via the communications network, a ping message to the exit proxy via the first bidirectional stream with the first intermediate proxy server;
receive, via the communications network, a pong message from the exit proxy, wherein the pong message is received via the second bidirectional stream with second intermediate proxy server, and wherein the pong message is responsive to the ping message; and
calculate a latency value based on a time the ping message was sent and a time the pong message was received.

15. The managing proxy server of claim 14, wherein the at least one processor is configured to repeatedly send the ping message according to a predefined frequency.

16. A non-transitory computer-readable device having instructions stored thereon that, when executed by at least one computing device, cause the at least one computing device to perform operations comprising:
in response to a command message from an exit proxy, establishing between a managing proxy server and a first intermediate proxy server, a first bidirectional stream via a communications network, wherein the command message comprises a group identifier and an exit proxy identifier of an exit proxy from a plurality of exit proxies, wherein the managing proxy server monitors a status for each of the plurality of exit proxies;
establishing, between the managing proxy server and a second intermediate proxy server, a second bidirectional stream via the communications network, wherein the second intermediate proxy server identifies the managing proxy server based executing a hash algorithm;
receiving, by the managing proxy server via the communications network, a request message specifying content to request from a target server;
establishing, between the managing proxy server and the first intermediate proxy server, a first unidirectional stream via the communications network;
transmitting, by the managing proxy server, the request message to the exit proxy via the first unidirectional stream with the first intermediate proxy server;
establishing, between the managing proxy server and the second intermediate proxy server, a second unidirectional stream via the communications network;
receiving, by the managing proxy server, the content from the target server via the second unidirectional stream with the second intermediate proxy server, wherein the content was retrieved from the target server by the exit proxy; and
transmitting, by the managing proxy server via the communications network, the target content to a message service.

17. The non-transitory computer-readable device of claim 16, wherein the second unidirectional stream is established by the second intermediate proxy server and in response to the second intermediate proxy server receiving the content from the target server.

18. The non-transitory computer-readable device of claim 16, the operations further comprising:
receiving, by the managing proxy server via the communications network, a shutdown command;
closing, by the managing proxy server, the first bidirectional stream with the first intermediate proxy server;
closing, by the managing proxy server, the second bidirectional stream with the second intermediate proxy server;
after the first and second bidirectional streams are closed, waiting, by the managing proxy server, a predefined time interval;
in response to determining that the predefined time interval has passed:
closing, by the managing proxy server, the first unidirectional stream with the first intermediate proxy server when the first unidirectional stream is not yet closed; and
closing, by the managing proxy server, the second unidirectional stream with the second intermediate proxy server when the second unidirectional stream is not yet closed.

19. The non-transitory computer-readable device of claim 16, the operations further comprising:
sending, by the managing proxy server via the communications network, a ping message to the exit proxy via the first bidirectional stream with the first intermediate proxy server;
receiving, by the managing proxy server via the communications network, a pong message from the exit proxy, wherein the pong message is received via the second bidirectional stream with second intermediate proxy server, and wherein the pong message is responsive to the ping message; and
calculating, by the managing proxy server, a latency value based on a time the ping message was sent and a time the pong message was received.

20. The non-transitory computer-readable device of claim 19, wherein the operations further comprise repeatedly sending, by the managing proxy server, the ping message according to a predefined frequency.
